(19) United States
(12) Patent Application Publication
(10) Pub. No.: US 2007/0113588 A1
(43) Pub. Date: May 24, 2007

(54) Method and facilities of manufacturing optical components and end items

(76) Inventors: Chien-Yi Huang, Taipei (TW); Jen-Feng Chang, Taipei (TW)

Correspondence Address: RABIN & BERDO, P.C., Suite 500, 1101 14th Street, N.W., Washington, DC, 20005, US

(21) Appl. No.: 11/283,726

(22) Filed: Nov. 22, 2005

(51) Int. Cl. C03B 11/00; C03B 13/00; C03B 9/16

(52) U.S. Cl. 65/66; 65/226

(57) ABSTRACT

This invention relates to a “method and facilities of manufacturing optical components and end items”, producing optical components by molding of separately heating glass and a mold, said manufacturing facilities comprises of a glass furnace and a glass molding machine. The glass furnace is applied to heat glass into a molten state and the mold is heated to temperature at 400˜500° C. in a glass molding machine. When molten glass passes through a furnace mouth comprising of a cooling pipeline and flows down on the mold of said glass molding machine, a cap, which is set inside the mold. It has a plurality of grappling hooks projecting outwards on the perimeter of the cap opening, during the shaping process, to be bent into claws and directly positioned inside the coagulated glass. Consequently, an optical component item is completed and integrated with said cap in one piece after molten glass is coagulated and shaped at one time.

### BACKGROUND OF THE INVENTION

I. Field of the Invention

The present invention is related to a “method and facilities of manufacturing optical components and end items”, especially with reference to a device of manufacturing optical components by molding, in order to reduce the time to replace the mouth of the furnace and the working procedure for additional assembly.

II. Description of the Prior Art

Generally, the past manufacturing means of conventional glass optical components is carried out through molding. With reference to FIG. 1, the common molding technique is by concurrently applying heat to the pre-cast molten glass gob with the mold, and when the temperature of the molten glass gob and mold rises to a certain temperature enabling the molten glass gob to be shaped by the glass molding machine; subsequently, the formed glass product which is the mold, is then taken out of the machine after the temperature has cool down.

Another glass forming method is applied to enable glass gob to be heated into a molten state by a glass furnace, after which the molten glass gob flows down over a mold on a glass molding machine through the mouth of a glass furnace (at this time, the mold temperature is about 400˜500° C.) and is pressed into a shape the same as the glass molding machine (the glass molding machine is often seen as a compression testing machine or a pressure forming machine ). Consequently, the finished piece of glass goods is taken out of the machine after the molten glass gob is shaped and coagulated.

Seeing that molten glass gob is formed by the capillarity between the internal channels inside a furnace mouth and the gravity, given this reason, the size of dropping molten glass gob into a glass pre-forming shape is influenced by the size of a glass furnace mouth. If various glass products are made, the sizes of dropping molten glass gobs into different glass pre-forming shapes, as well as the sizes of various furnace mouths, may vary. However, the machine temperature is required to be cooled down, or the machine needs to be shut down each time when a furnace mouth is changed; in addition, a newly replaced mold on the machine must be heated again after the replacement of said furnace mouth, resulting in a large reduction in productivity. Moreover, conventional molding method requires different molds and glass gobs to be repeatedly heated up and cooled down, so a manufacturer must select various metallurgic powder and materials with higher unit prices, resulting in a great increase in the manufacturing costs.

Furthermore, an optical component that is made by either molding methods mentioned above is composed of coagulated and shaped glass and cap; and the glass is fixed on the front end of the cap by gelatin agglutination or an additional positioning component, resulting in increase of extra assembly working process and related manufacturing costs. In addition, having gelatin agglutination method of fixing glass on the cap easily causes the falling-off problem. In view of the above, an innovative “method and facilities of manufacturing optical components and end items” is provided herein to improve the drawbacks of conventional manufacturing devices and finished goods.

### SUMMARY OF THE INVENTION

The primary objective of the present invention is to provide a method and facilities of manufacturing optical components for reducing the time in changing the furnace mouth, and further increasing the productivity.

Another objective of the present invention is to make optical finished goods by directly integrating glass and cap, when glass gob is shaped, so as to reduce an extra assembly working process and enable the formed product to be more secured.

To achieve these objectives, the “method and facilities of manufacturing optical components and end items” of the invention is applied to make an optical component by separately heating molten glass gob and a mold by a manufacturing device, which is divided into a glass furnace and a glass molding machine. When glass gob is heated into a molten state in a glass furnace, a mold is heated to temperature at 400˜500° C. in a glass molding machine, after which the molten glass gob passes through a furnace mouth of glass furnace, and having a cooling pipeline set thereon, continues to flow down on said mold on the glass molding machine. A cap is pre-set inside the mold and a plurality of grappling hooks are set on the perimeter of the cap opening, which are bent into claws during the process of forming glass gob into a shape, to directly position the shaped glass item. Consequently, the invention enables an optical component item to be produced and integrated with cap in one piece at the same time during the one-time process. The manufacturing device is divided into two parts: a glass furnace and a glass molding machine (generally, a compression testing machine or a pressure forming machine), where the glass furnace is applied to the heated glass gob into a molten state; in addition, a cooling pipeline is set on the upper perimeter outside the furnace mouth for low-temperature inert gas or other cooling fluid to pass through. Moreover, seeing that an extremely small glass fiber is generated owing to traction force (pulling power), during the process when molten glass gob passes through a furnace mouth and drops down onto a mold on the glass molding machine, a trimming appliance is thus set on the location of dropping the glass gob inside the mold. Moreover, the glass molding machine mainly comprises an upper mold, a lower mold, a cap appliance and a heating apparatus. Cavities corresponding to the glass shape are respectively set inside upper and lower molds; a cavity is set on a proper location corresponding to the position of the cap; in addition, cap appliance is set between upper and lower molds. A cap is set inside the cap appliance, directly integrating in one piece with glass gob into an optical component item; moreover, the cap has the perimeter of an opening on one lateral side thus setting a plurality of grappling hooks projecting outwards without being bent; when the cap appliance is tightly clamped with the upper and the lower molds, the clamp force in-between enables the grappling hooks to be bent into claws piercing inside molten glass gob, which has not yet coagulate in the mold, and integrating the cap with glass item in one piece.

Molten glass gob naturally flows down by the influence of the capillarity of channel inside the furnace mouth and the gravity during the manufacturing. Therefore, the furnace mouth applied by the invention has the external wall on the upper perimeter to set a cooling pipeline for low-temperature inert gas or other cooling fluid to pass through, thereby the temperature of furnace mouth is lowered from outside in, enabling glass gob near the external wall to be coagulated and shaped, so as to narrow the bore of the channel for molten glass gob to flow through. Therefore, the invention applies by way of a method and facilities, to reduce the size of glass gob flowing without changing of different furnace mouth sizes or shutting down the machine, in addition, the invention possesses the effect of stopping glass gob flowing without the need of an extra device. Nevertheless, an extremely small glass fiber is generated owing to traction force (pulling power), during the process when molten glass gob passes through a furnace mouth and flows down on a mold on glass molding machine. This is especially so, when glass gob is moving off the glass furnace mouth, and given this reason, a trimming appliance of the invention is designed to cut glass fiber when glass flows into a mold on the machine. Moreover, the invention is applied to separately heat molten glass gob and a mold, and mold is heated to temperature at 400˜500° C. in a glass molding machine without repeated processes of rising and lowering temperature, so that the mold does not need powder metallurgy materials with high unit prices. Instead, the invention applies stainless steel with lower price to further reduce the mold manufacturing costs.

Furthermore, the invention applies the characteristic of shaping by claming upper mold and lower mold onto the mold. In addition, a cap is pre-set inside the mold and a plurality of grappling hooks are pre-set to project outwards without being bent on the perimeter of the cap opening, which are bent into claws during the process of forming molten glass gob into a shape and are made to pierce through molten glass gob which has not yet coagulate inside the mold. Consequently, an optical component item is completed and integrated with the cap in one piece after molten glass is coagulated and shaped, so as to reduce an additional assembly working process of conventional method; in addition, such method of integrating the glass item and said cap in one piece enables a more stable and secured structure.

### BRIEF DESCRIPTION OF THE DRAWINGS

FIG. 1 is a flowchart showing the manufacturing method of conventional optical components

FIG. 2 is a flowchart showing the manufacturing method of the invention

FIG. 3 is a structural diagram of a manufacturing device according to the present invention

FIG. 4 is a three-dimensional view showing a cap of the present invention

FIG. 5 is a three-dimensional view showing an optical finished item of the invention

FIG. 6A is an activity view (I) showing a first embodiment of the present invention

FIG. 6B is an activity view (II) showing the first embodiment of the present invention

FIG. 6C is an activity view (III) showing the first embodiment of the present invention

FIG. 6D is an activity view (IV) showing the first embodiment of the present invention

FIG. 7A is an activity view (I) showing a second embodiment of the present invention

FIG. 7B is an activity view (II) showing the second embodiment of the present invention

FIG. 7C is an activity view (III) showing the second embodiment of the present invention

FIG. 7D is an activity view (IV) showing the second embodiment of the present invention

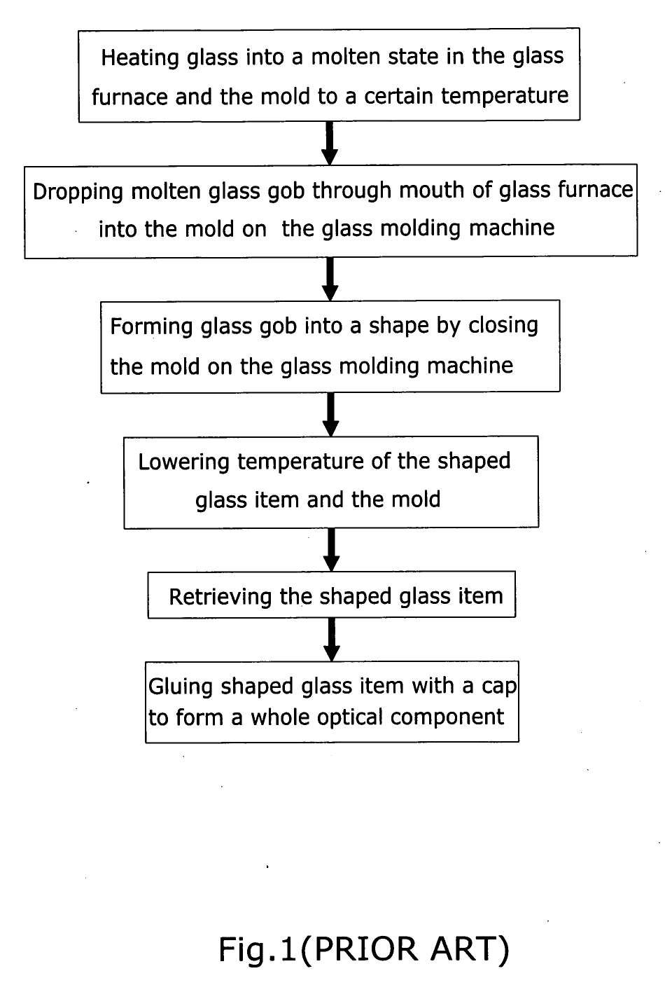

### DESCRIPTION OF THE PREFERRED EMBODIMENT

Further aspects, objects, and desirable features of the invention will be better understood from the detailed description and drawings that follow in which various embodiments of the disclosed invention are illustrated by way of examples:

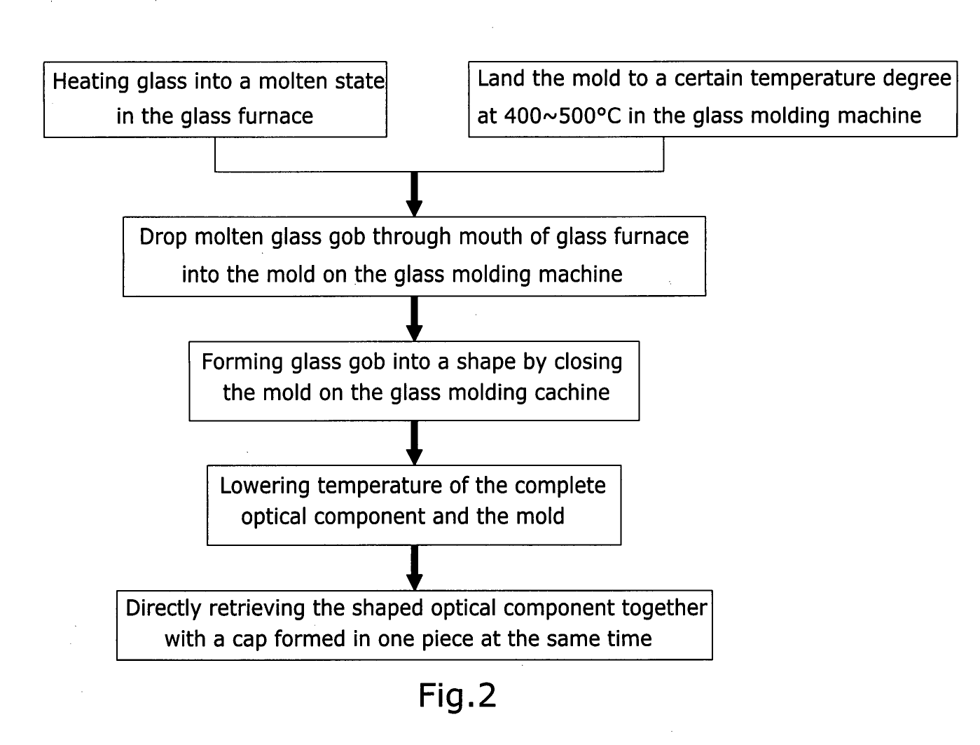

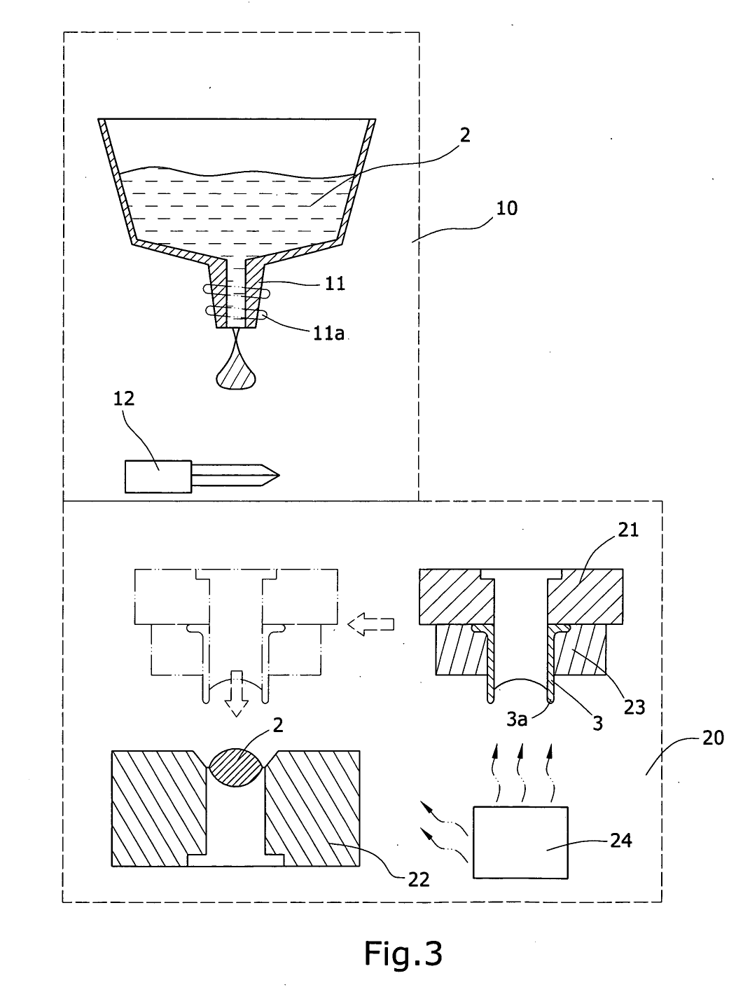

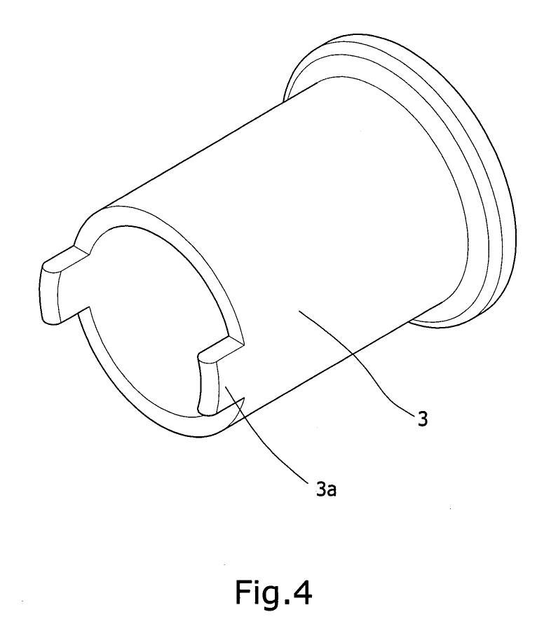

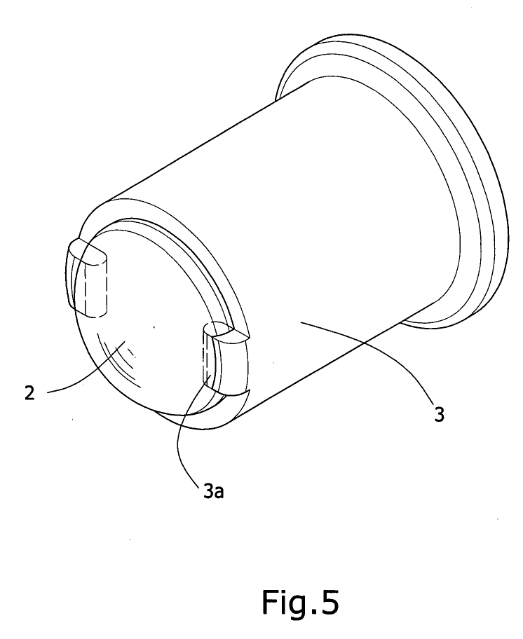

With reference to FIGS. 2, 3, 4 and 5, the “method and facilities of manufacturing optical components and end items” of the invention applies the method of separately heating glass gob and a mold to produce an optical component item, and the manufacturing device is divided into two parts of a glass furnace and a glass molding machine, where the glass furnace is applied to heat glass gob into a molten state and the mold is heated to temperature at 400˜500° C. in a glass molding machine. The molten glass gob then passes through a furnace mouth of glass furnace having a cooling pipeline set therein, and flows down on the mold on the glass molding machine. A cap is pre-set inside the mold and a plurality of grappling hooks set on the perimeter of the cap opening, which are bent into claws during the process of forming glass gob into a shape, to be directly positioned inside the shaped glass item. Consequently, the invention enables an optical component item to be produced and integrated with the cap in one piece at the same time during the one-time process.

In view of the above, the manufacturing device is divided into two parts: a glass furnace 10 and a glass molding machine 20, wherein:

The glass furnace 10 is applied to heat glass gob 2 into a molten state, in addition, a cooling pipeline 11a is set on the upper perimeter outside the furnace mouth 11, after which a cooling pipeline channel 11a allows low-temperature inert gas or other cooling fluid to pass through. Moreover, extremely small glass fiber is generated owing to traction force (pulling power), during the process when molten glass gob 2 passes through the furnace mouth 11 and flows down on a mold on the glass molding machine 20. Therefore, a trimming appliance 12 is set on the location of dropping the glass gob 2 inside the mold.

The glass molding machine 20 mainly comprises of an upper mold 21, a lower mold 22, a cap appliance 23 and a heating apparatus 24; cavities corresponding to the glass shape are respectively set inside upper and lower molds 21 and 22; a cap 3 corresponding to cavities is set on proper location inside the cap appliance 23. In addition, the cap appliance 23 is set between upper and lower molds 21 and 22 and moreover, the cap 3 is set inside cap appliance 23, thus directly integrating in one piece with glass gob into an optical component item. Cap 3 has the perimeter of an opening on one lateral side thus setting a plurality of grappling hooks 3a to project outwards without being bent. When cap appliance 23 is tightly clamped with the upper and the lower molds 21 and 22, the clamp force in-between enables grappling hooks 3a to be bent into claws, piercing inside molten glass gob 2 which has not yet coagulate in the mold and integrating the cap 3 with glass item into one piece.

Therefore, a formed optical component item comprises of a metal portion of cap 3 and glass 2. In addition, the grappling hooks 3a on the front end of said cap 3 after being bent into claws are able to integrate with glass 2 in one piece, forming a more stable and secured structure without causing the problem of easily falling-off.

In accordance with the method and facilities above, there are two embodiments described as follows:

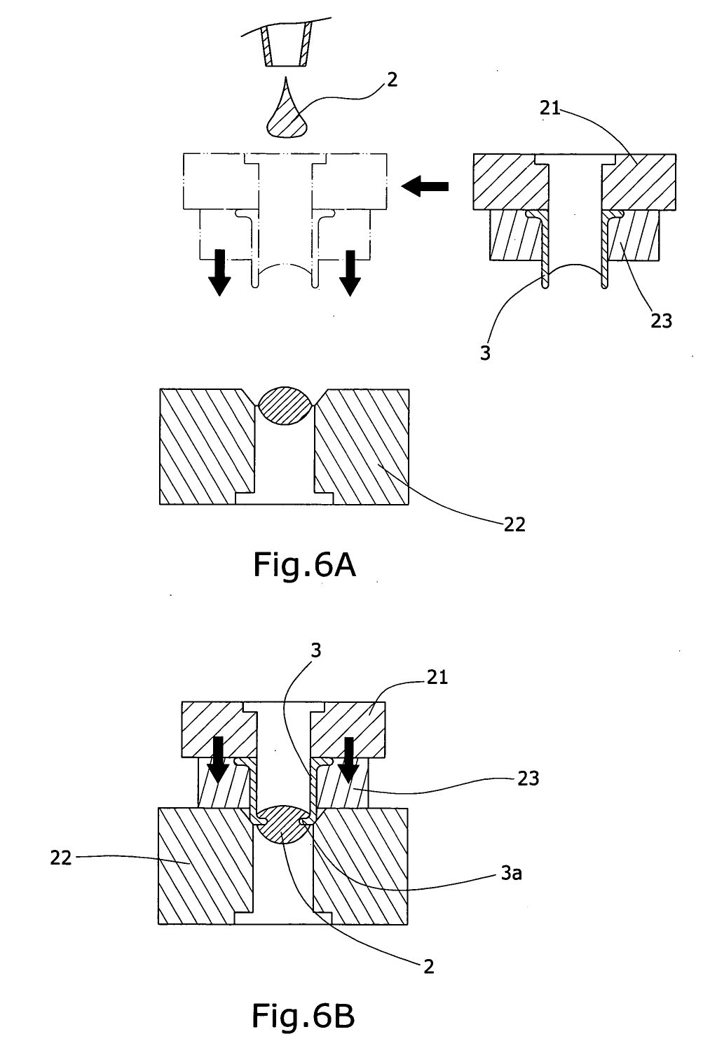

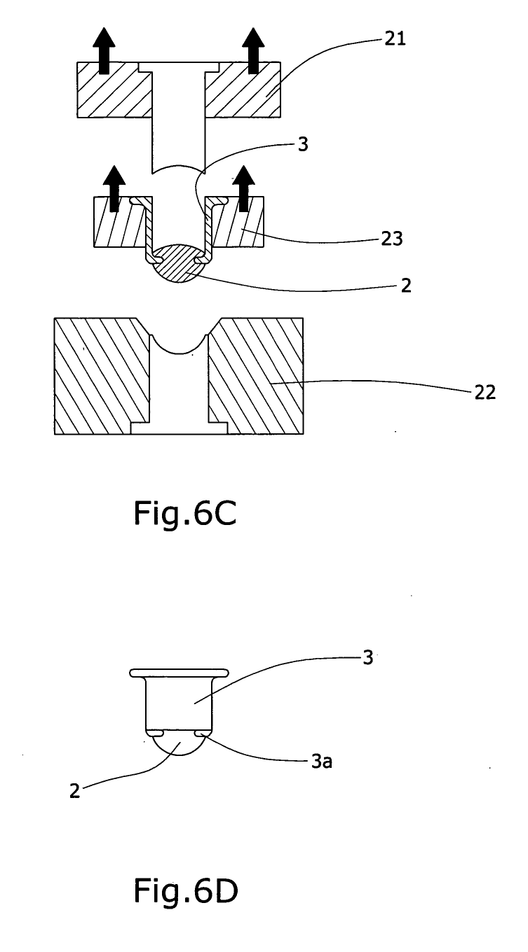

With reference to a first preferred embodiment shown in FIGS. 6A˜6D, the cap 3 is pre-set on the cap appliance 23 inside the upper mold 21. When the temperature of cap 3 is the same as the mold temperature and glass gob 2 drops into the lower mold 22, the mold is shifted to enable the upper and the lower molds 21 and 22 to be on the same pivot. The mold is then pressed to be close, and the grappling hooks 3a which, has not been bent on the front end of the cap 3, is then bent at the same time when the cap appliance 23 and the lower mold 22 clamps together. Subsequently, claws 34 of grappling hooks are inserted into glass 2 owing to the claming motion, so that cap 3 and glass 2 are integrated into one piece. Glass 2 is gradually coagulated and the finished item is retrieved out of the mold after the temperature has cooled down.

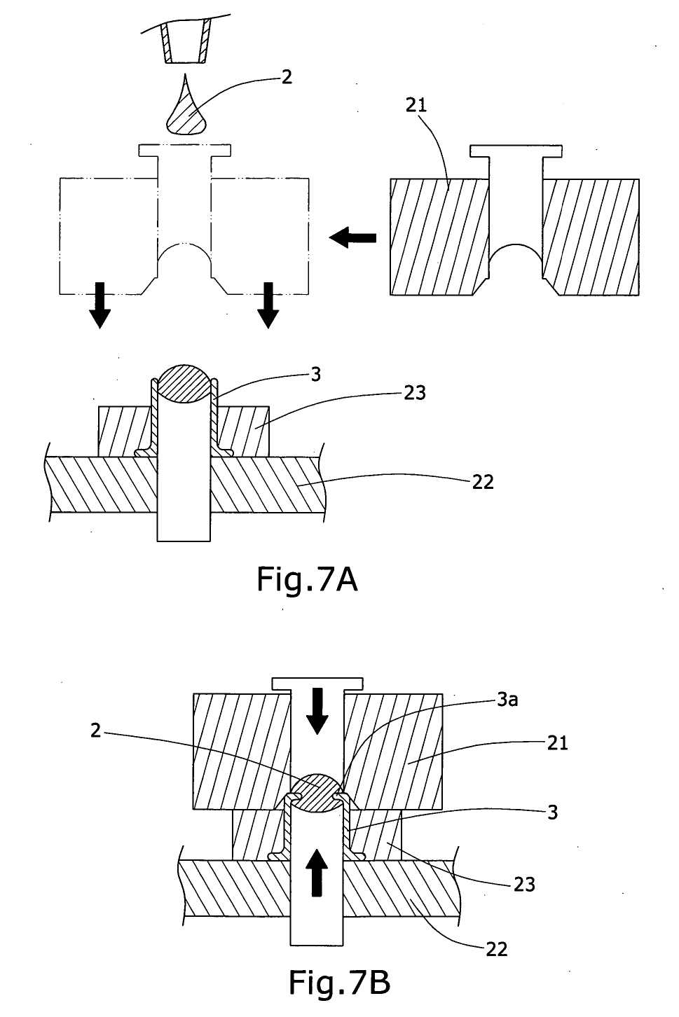

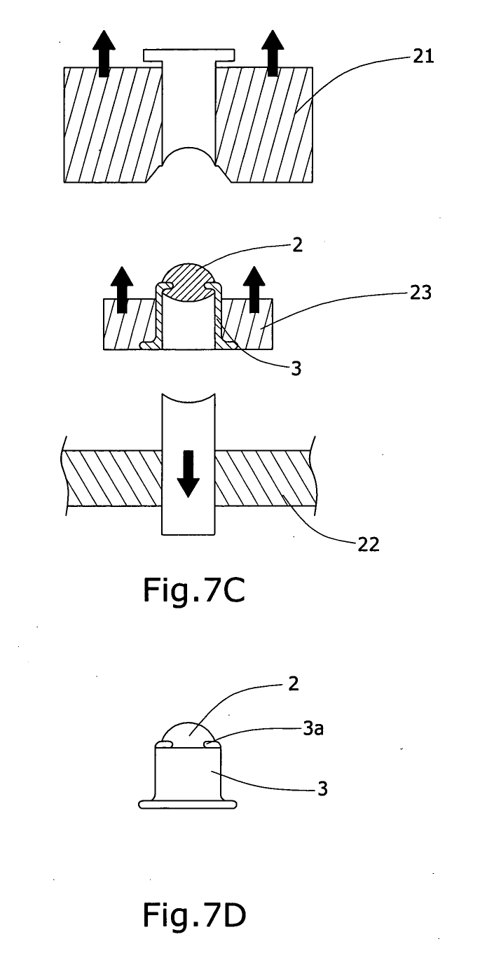

With reference to a second embodiment shown in FIGS. 7A˜7D, cap 3 is positioned on cap appliance 23 inside the lower mold 22. When the temperature of cap 3 is the same as the mold temperature and glass gob 2 drops into cap 3 and the lower mold 22, the mold shifts to enable the upper and the lower molds 21 and 22 to be on the same pivot. The cap appliance 23 positioned on top of the lower mold 22 clamps with the upper mold 21 to bend grappling hooks 3a, which is then inserted into shaped glass 2. Consequently, cap 3 and glass 2 are integrated into one piece where glass 2 is then gradually coagulated and the finished item is retrieved out of the mold after the temperature has cooled down.

To summarize, the present invention is related to a “method and facilities of manufacturing optical components and end items” taking advantage of the cooling pipeline design in the furnace mouth to reduce the time in changing different furnace mouths and increase productivity. In addition, the design of integrating an optical component item with the cap in one piece without the need of extra assembly working process, so as to facilitate the production speed and bring about a more stable and secured structure without causing the problem of easily falling-off. Therefore, the invention possesses the effects of “practicability” and “advancement” in the industry.

Many changes and modifications in the above-described embodiments of the invention can, of course, be carried out without deviating from the scope. Accordingly, to promote the progress in science and the use of arts, the invention is disclosed and intends to be limited only by the scope of the appended claim.

What is claimed is:

1. Type of “method of manufacturing optical components”, primarily applies the molding by separately heating glass and a mold to produce optical components. Manufacturing facilities comprises of a glass furnace and a glass molding machine, with the glass being heated into a molten state in the glass furnace and the mold is heated to a temperature at 400˜500° C. in the glass molding machine. The molten glass gob passes through a furnace mouth of the glass furnace, having a cooling pipeline set therein, then flows down on the mold on the glass molding machine. A cap is pre-set inside the mold and a plurality of grappling hooks are set on the perimeter of the cap opening, which are bent into claws during the process of forming the glass gob into a shape, so as to directly position the shaped glass item inside. Consequently, an optical component item is produced and integrated with cap in one piece at the same time during the one-time process.

2. Type of “facilities of manufacturing optical components”, comprising of a glass furnace and a glass molding machine, where the glass furnace is applied to heat the glass into a molten state inside. In addition, a cooling pipeline is set on the upper perimeter outside the furnace mouth and a cooling pipeline channel allows low-temperature inert gas or other cooling fluid to pass through. Seeing that an extremely small glass fiber is generated owing to traction force (pulling power), during the process where molten glass gob passes through the furnace mouth and flows down onto a mold on the glass molding machine, where a trimming appliance is set on the location of dropping the glass gob inside the mold. The glass molding machine mainly comprises of an upper mold, a lower mold, a cap appliance and a heating apparatus. Cavities corresponding to the glass shape are respectively set inside upper and lower molds and cavities corresponding to the cap are positioned on proper locations on the cap appliance. In addition, cap appliance is set between upper and lower molds moreover; a cap is set inside cap appliance, directly integrating in one piece with glass gob into an optical component item.

3. Type of “manufacturing optical components and end items”, comprising of metal portion of the cap and glass, where the grappling hooks positioned on the front end of the cap is completely integrated with glass after being bent into claws.

4. Type of “method and facilities of manufacturing optical components and end items” of claims 1, where the cap has the perimeter of an opening on one lateral side thus setting a plurality of grappling hooks projecting outwards without being bent.

5. Type of “method and facilities of manufacturing optical components and end items” of claims 2, where the cap has the perimeter of an opening on one lateral side thus setting a plurality of grappling hooks projecting outwards without being bent.

6. Type of “method and facilities of manufacturing optical components and end items” of claims 3, where the cap has the perimeter of an opening on one lateral side thus setting a plurality of grappling hooks projecting outwards without being bent.

7. Type of “method and facilities of manufacturing optical components and end items” of claims 1, where the cap is pre-set on the cap appliance inside the upper mold, when the temperature of the cap is the same as the mold temperature and the glass gob drops into the lower mold, the mold shifts to enable the upper and the lower molds to be on the same pivot and when the mold is pressed to be closed, the grappling hooks has not been bent on the front end of the cap is then bent at the same time when the cap appliance and the lower mold clamp together. Subsequently, claws of the grappling hooks are inserted into the glass owing to the claming motion, so that the cap and the glass are integrated into one piece when the glass is gradually coagulated and the finished item is retrieved out of the mold after the temperature has cooled down.

8. Type of “method and facilities of manufacturing optical components and end items” of claims 2, where the cap is pre-set on the cap appliance inside the upper mold, when the temperature of the cap is the same as the mold temperature and the glass gob drops into the lower mold, the mold shifts to enable the upper and the lower molds to be on the same pivot and when the mold is pressed to be closed, the grappling hooks has not been bent on the front end of the cap is then bent at the same time when the cap appliance and the lower mold clamp together. Subsequently, claws of the grappling hooks are inserted into the glass owing to the claming motion, so that the cap and the glass are integrated into one piece when the glass is gradually coagulated and the finished item is retrieved out of the mold after the temperature has cooled down.

9. Type of “method and facilities of manufacturing optical components and end items” of claims 1, where the cap is pre-set on the cap appliance inside the upper mold, when the temperature of the cap is the same as the mold temperature and the glass gob drops into the lower mold, the mold shifts to enable the upper and the lower molds to be on the same pivot and when the mold is pressed to be closed, the grappling hooks has not been bent on the front end of the cap is then bent at the same time when the cap appliance and the lower mold clamp together. Subsequently, claws of the grappling hooks are inserted into the glass owing to the claming motion, so that the cap and the glass are integrated into one piece when the glass is gradually coagulated and the finished item is retrieved out of the mold after the temperature has cooled down.

10. Type of “method and facilities of manufacturing optical components and end items” of claims 2, where the cap is pre-set on the cap appliance inside the lower mold. When the temperature of the cap is the same as the mold temperature and the glass gob flows into the cap and the lower mold, the mold shifts to enable the upper and the lower molds to be on the same pivot and after which the cap appliance positions on top of the lower mold and clamps with the upper mold to bend the grappling hooks. Subsequently, claws of the grappling hooks are inserted into said glass owing to the clamping motion, so that the cap and the glass are integrated into one piece. The glass is gradually coagulated and the finished item is retrieved out of the mold after the temperature has cooled down.
